(19) United States
(12) Patent Application Publication
(10) Pub. No.: US 2003/0083134 A1
(43) Pub. Date: May 1, 2003

(54) Flexible coupling device

(76) Inventor: Stanley J. Day, Roseville, MN (US)

Correspondence Address: Jeffery L. Cameron, NAWROCKI, ROONEY & SIVERTSON, P.A., Broadway Place East, Suite 401, 3433 Broadway Street Northeast, Minneapolis, MN, 55413, US

(21) Appl. No.: 10/035,378

(22) Filed: Oct. 26, 2001

(51) Int. Cl. F16D 3/26; F16D 3/16; F16D 3/50

(52) U.S. Cl. 464/112

(57) ABSTRACT

A flexible coupling for connecting two objects together, the coupling has a first member, a second member, a bearing, and one or more torsion resistant mechanisms. The members each are constructed and arranged to engage the bearing, such that, at least one of the members may pivot around the bearing, with respect to the other member, thereby allowing at least one of the members to be moveably engaged with the bearing. The torsion resistant mechanisms are constructed and arranged to resist the transmission of a torsional load, applied to one of the members, to the other member. One or more of the torsion resistant mechanisms may also be constructed and arranged to reduce vibrational forces applied to the device.

### BACKGROUND OF THE INVENTION

The present invention relates generally to the field of coupling devices. In particular, the present invention relates to a flexible coupling for use as a coupling between two objects. The device may be applied in many fields wherein vibrational forces and torque loads are drastically different. For example, the device may be applied to fields wherein little or no torque is exerted, such as in the field of prosthetic joints for elbows, knees, etc, or may be used wherein a large amount of torque is delivered to the coupling, such as in the field of variable and high velocity drive shaft couplings. Additionally, the device may be utilized in any field, wherein a moderate amount of vibrational forces or torque loads are experienced, which fall between the above extremes.

Typically, coupling devices are designed to benefit a particular work environment based upon the amount of force that is applied to the coupling. Couplings for use in the prosthetics industry must be capable of withstanding relatively light forces, but must be simple in design and durable, for long-term implantation without damage or malfunction.

In the fields of variable and constant velocity drive shafts, couplings are exposed to significant forces from both the movement of the drive shaft or the driven device, or from torque provided by the rotation of the drive shaft. For most flexible couplings utilized in this field, the most common forces are presented through torque which is applied to the device by the drive shaft.

Couplings used in constant velocity situations deal with fatigue due to wear and tear based upon a constant application of torque over time. In order for a device to work in these conditions, the device must be durable and constructed to withstand the buildup of energy that is constantly transferred from the drive shaft to the coupling.

Couplings that are used in variable velocity situations have problems that differ greatly from those utilized in constant velocity or no velocity situations. One issue of great importance in a variable velocity situation is shock loads which are delivered both to the drive shaft and to the component being run by the drive shaft. Such shock loads are detrimental to the drive shaft, and especially to the component that is being run by the drive shaft, such as a pump. Shock loads are derived from the change in velocity of the drive shaft that produce additional torque to the coupling for short periods of time. A device used in this field must be able to withstand surges of torque and be able to dissipate or dampen the corresponding energy that is attempting to be transferred to the coupling from the drive shaft.

Simple vibrations caused during use under vibration causing conditions, such as use in a vehicle for rough terrain, may cause the coupling to wear prematurely. Also, typically, traditional couplings tend to transmit all of these vibrational forces from one object to the second object. It is, therefore, desirable that the transmission of these simple vibrational forces be reduced or, if possible, eliminated.

Another issue associated with coupling devices is the potential for abuse of the structural components from harmonic resonance. In particular, any rotating object has one or more natural torsional frequencies. When an object's speed corresponds to one of these natural frequencies, a resonance occurs. At these resonant speeds, the amplitude of vibrations within the device is greatly magnified. The resonance can quickly destroy bearings, mounts, and other connected equipment, including the drive shaft. Next to catastrophic overloads, operating in a resonance condition is probably the fastest way to destroy rotating equipment.

Another type of coupling that is commonly used to connect two drive shafts is a conventional universal joint. For the most part, these types of couplings directly transmit shock loads from the drive shaft to the driven object and may themselves be harmed or fatigued over time because of such shock loads. These types of devices are generally not suitable for applications wherein high shock loads or large simple or harmonic vibrations are produced.

Additionally, when a conventional universal joint is pivoted, the rotation of the joint produces a vibration due to the fact that the portion of the device on the inside of the bend travels slower than the portion on the outside of the bend. Consequently, the greater the angle to which these conventional universal couplings are articulated, the greater the vibration created.

The present invention addresses these needs, as well as other problems associated with coupling devices. The present invention offers advantages over the prior art and solves problems associated therewith.

### SUMMARY OF THE INVENTION

The present invention provides a flexible coupling for connecting two objects together, the coupling has a first member, a second member, a bearing, and one or more torsion resistant mechanisms. The members each are constructed and arranged to engage the bearing, such that, at least one of the members may pivot around the bearing, with respect to the other member, thereby allowing at least one of the members to be moveably engaged with the bearing. The torsion resistant mechanisms are constructed and arranged to resist the transmission of a torsional load, applied to one of the members, to the other member. One or more of the torsion resistant mechanisms may also be constructed and arranged to reduce vibrational forces applied to the device.

The torsion resistant mechanisms may be constructed of one or more of the following structures. The torsion resistant mechanisms may include: one or more flexible elements attached between the first member and the second member or one of the members and the bearing; one or more bumper elements attached to the bearing and/or the member(s); a surface attached to one of the members that engages a surface attached to the other member to restrict the torsional movement of the first and second members with respect to each other, and/or a shear member, provided in the engagement of the surfaces, wherein the shear member has a maximum load resistance that is lower than the maximum load resistance of the engagement of the surfaces.

The device may also be designed with a rapid repair structure, wherein at least one of the members has an engagement portion that is in engagement with the bearing, that is selectively releasable from engagement with the bearing, thereby allowing the engagement portion to be released, such that the engagement around the bearing can be can be temporarily disconnected without having to remove the entire coupling device.

Any suitable flexible element structures known in the art may be utilized, for example, generally L-shaped members having one end engaged with the first member and the other end engaged with the second member are one such structure.

The flexible elements may also utilize a grommet interposed between one or both of the ends of the flexible element and the member to which the end is attached.

Any suitable bumper element structures known in the art may be utilized, for example, resilient ring shaped flexible elements may be utilized.

Preferably, the torsion resistant mechanisms may advantageously be constructed and arranged such that their individual resistances can be added together to provide a greater overall resistance force for the device. For example, the torsion resistant mechanisms may be comprised of first and second mechanisms, wherein the two mechanisms each have a predetermined maximum load resistance. The mechanisms are constructed and arranged on the device such that, when the first mechanism approaches its maximum load resistance, the second mechanism becomes engaged to provide additional resistance to that of the first mechanism. This concept can be applied to several torsion resistant mechanisms present on the device. For example, the torsion resistant mechanisms comprise three or more mechanisms having predetermined maximum load resistances, wherein the three or more mechanisms are constructed and arranged such that when the first mechanism approaches its maximum load resistance, as described above, the second, third, fourth, etc. mechanisms become engaged to incrementally provide additional resistance to that of the first mechanism, and thereafter, the combined mechanisms: first and second; first, second, and third; and so on.

The above mentioned benefits and other benefits of the invention will become clear from the following description by reference to the accompanying drawings.

### DESCRIPTION OF THE DRAWINGS

FIG. 1 is an assembly view of one embodiment of the device illustrating the parts of an unassembled coupling of the present invention;

FIG. 2 is an assembly view of one embodiment of an engagement member, as shown in FIG. 1, of the present invention;

FIG. 3 is an assembly view of another embodiment of an engagement member, as shown in FIG. 1, of the present invention;

FIG. 4 is a side perspective view of the embodiment of FIG. 1; and

FIG. 5 is an assembly view of another embodiment of the device illustrating the parts of an unassembled coupling of the present invention.

### DESCRIPTION OF THE PREFERRED EMBODIMENT

The present invention is a flexible coupling device that is utilized to connect two objects together, while allowing them to pivot, with respect to each other, around the bearing. This allows the transmission of a torque force from one object to the other through the coupling, even though two objects are pivoted at an angle to each other.

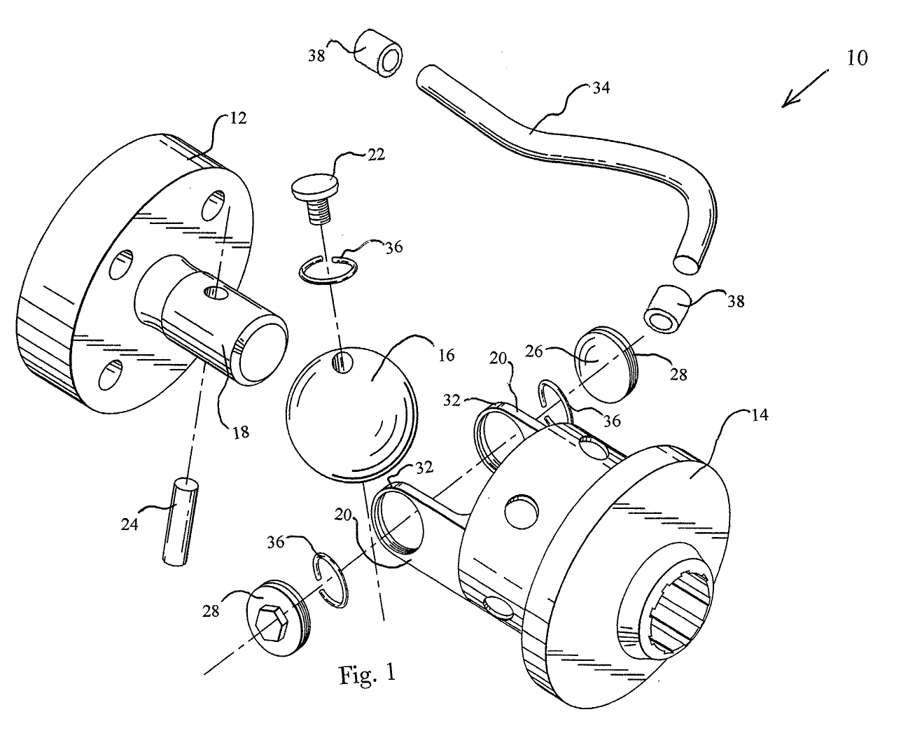

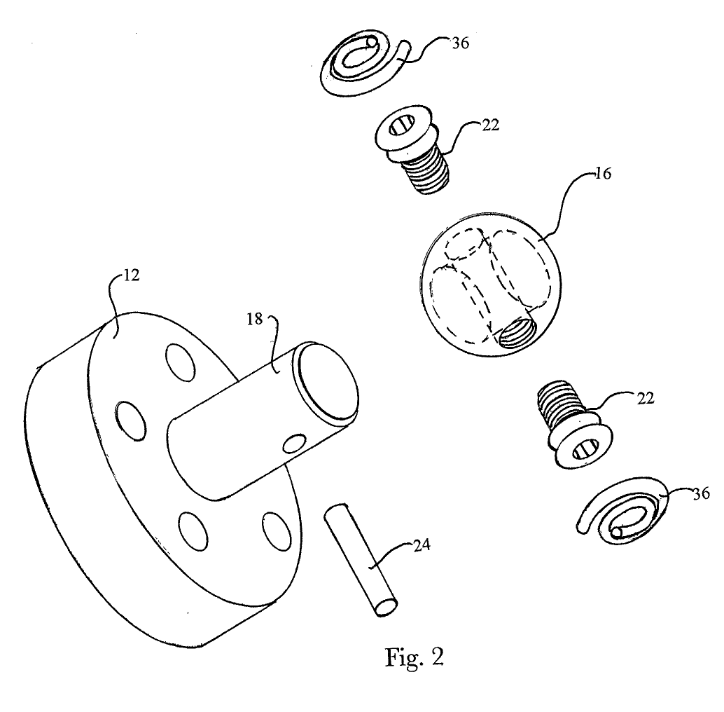

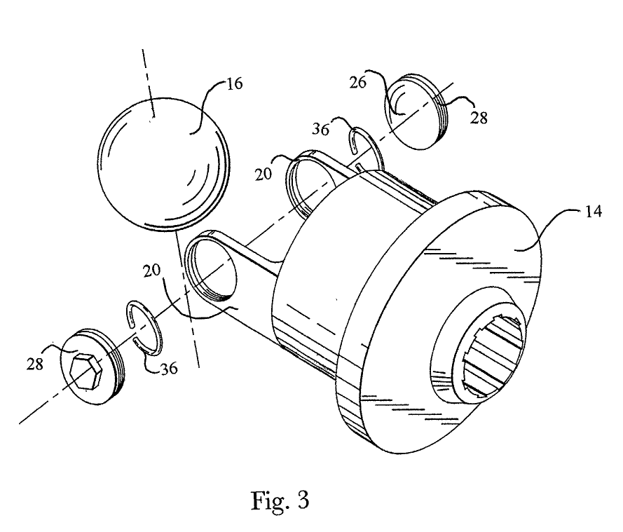

One embodiment of the device is generally shown in FIGS. 1-4, the device 10 of the present invention is comprised of first and second members. When assembled with the bearing 16, these members 12 and 14 engage the bearing 16, such that the members cannot be detached from the bearing. In this way, they can pivot around the center of the bearing and thereby pivot with respect to each other.

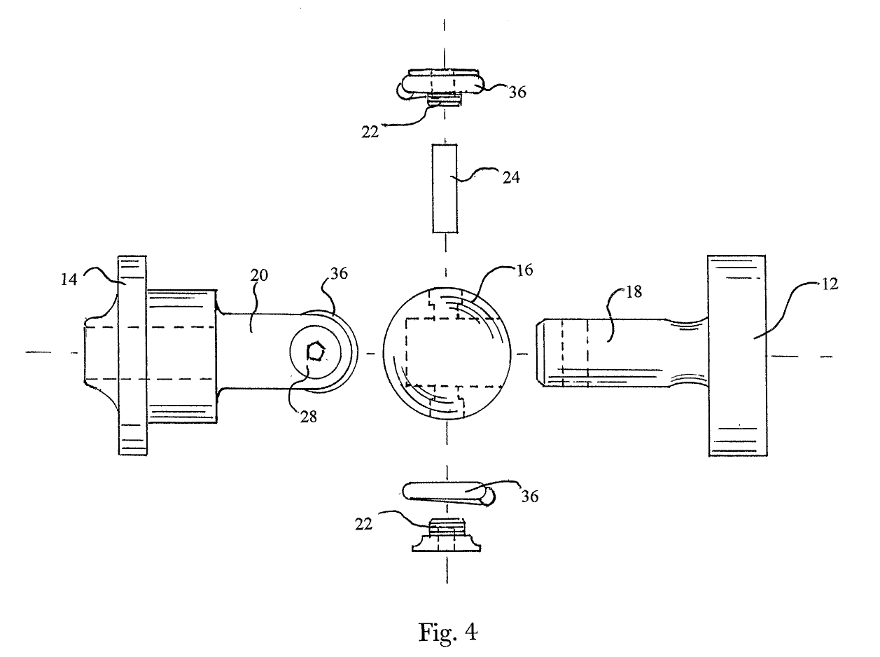

In the embodiment, shown in FIGS. 1 and 4, the device utilizes two different style members, one member 12 having a stem 18 that is mounted within the bearing 16, and a member 14 having two arms 20 extending to engage the exterior surface of the bearing 16. Another embodiment of the device is shown wherein the two members each have arms 20 that engage the exterior of the bearing 16.

With respect to the stem-style member 12 of the embodiment of FIGS. 1 and 4, the member 12 is generally constructed having a stem 18 that is sized to fit into a cavity formed in the surface of the bearing 16. The stem 18 and corresponding cavity may be sized and shaped in any configuration known in the art. For example, a circular cylindrical configuration is shown in the Figures, however, a polygon cylindrical configuration may be utilized.

The stem 18 is attached to the bearing 16 by any means known in the art. For example, as shown in the figures, the stem may be maintained through the use of screws 22 placed through an aperture in the bearing 16. The screws utilized may be designed such that their heads are flush with the surface of the bearing or may be designed to extend above the surface of the bearing, to accommodate bumper elements 30 thereon.

In the example shown in the figures, an optional shear member 24 has also been provided. In the embodiment shown, the shear member 24 is a shear pin placed in the aperture, and maintained therein by two screws 22 mounted in the ends of the aperture. The shear member 24 has a length that is greater than the diameter of the stem 18. The shear member 24, preferably has a maximum torque resistance that is less the torque resistance of the other components of the device 10. In this way, the shear member 24 is a simple and easily replaceable component and is designed to fail before one of the other more complex components of the device does.

A stem-style member 12 can be coupled with a arm-style member 14 such as that depicted in FIGS. 1, 3, and 4. The arm-style member 14 is generally comprised of two or more arms 20 that provide engagement surfaces 26 to engage the exterior surface of the bearing 16. The arms and consequently the surfaces 26 must be positioned to contain the bearing 16 between the engagement surfaces 26 during use of the device.

In the embodiment shown, engagement members 28, having engagement surfaces 26 thereon, are releasably mounted to the arms 20 to allow the members 28 to be removed to allow the coupling of the member 14 with the bearing 16 to be easily disconnected, or to allow the replacement of the engagement surface 26. This feature may also be useful in circumstances, such as, the replacement of the surfaces for repair or for allowing the use of different surfaces for different sized bearings. The engagement members 28 may also be designed to accommodate the mounting of bumper elements 30 thereon. Additionally, the arms 20 of the member 14 may be designed to accommodate the use of bumper elements 30. One suitable example, as shown in FIGS. 1 and 4, provides that the arms 20 have a slot 32 formed in their end surface to allow the exterior surface of a bumper member 26 to protrude through the slot 32.

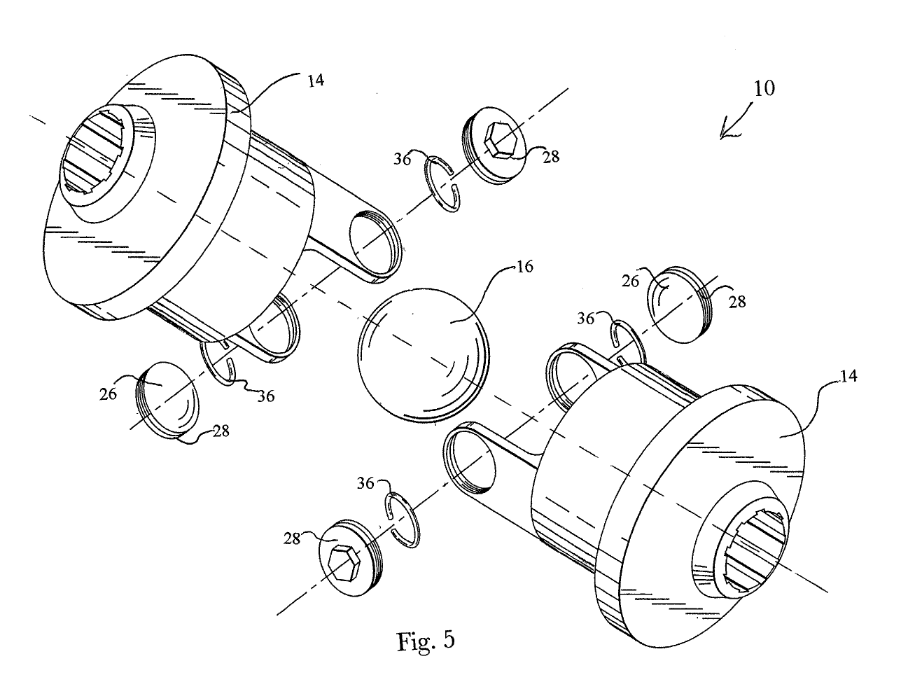

As shown in FIG. 5. Two arm-style members 14 may be utilized together to form an embodiment of the present invention. In this embodiment, two members 14 each having arms 20 thereon are mounted around the bearing 16 such that they each can pivot with respect to the center of the bearing 16. FIG. 5 shows the device 10 equipped with bumper elements 30 for providing torque resistance and may also be equipped and designed having any other torsion resistance mechanisms known in the art.

The device 10 may utilize one or more torsion resistance mechanisms. Several such mechanisms are illustrated herein, although any mechanisms known in the art may be utilized. For example, in FIG. 1, the device 10 is constructed to utilize flexible elements 34, bumper elements 36, a locking condition between the two members, and a shear member 24. Each of these structures provides torsion resistance and when combined can create a greater resistance than any one of the single structures can.

Additionally, the mechanisms can be arranged such that they can provide incremental increases in resistance as the torque loads placed on the device increase. For example, a first mechanism can be utilized to resist torque to a predetermined maximum amount. This amount is typically determined based upon the size of the elements and the materials used to fabricate the elements. The device can be designed such that as these elements begin to approach their maximum resistance, a second mechanism begins to resist the torque forces in addition to the resistance of the first mechanism. The device can then be designed such that when the combined resistance of the first two mechanisms approaches its maximum, a third mechanism begins to resist the torque forces in addition to the combined resistance of the first two mechanisms. In this way, the device can be sensitive to lower loads by using a lower incremental resistance force, while still being able to handle higher forces.

Flexible elements 34 such as the L-shaped elements or the ring shaped elements 36 shown in the figures are two suitable structures for use as torque resistance mechanisms. In the embodiment shown in FIG. 1, the L-shaped elements 34 are mounted to the first and second members. The ends of the elements 34 are placed in cavities formed in the surfaces of the members 12 and 14. The ends may be fixed in the cavities, however if the ends are mounted such that they can rotate, the L- shaped members 34 can simply twist to provide a first torsion resistance mechanism and can also bend to provide a second mechanism. When not fixed to the members 12 and 14, grommets 38 may be used to help keep the ends of the elements 34 within the confines of the cavities. Flexible elements 34 may also be mounted between the bearing 16 and one or both of the members 12 and/or 14, or may, alternatively, be mounted separately to the bearing 16 and to one or both of the members 12 or 14. For example, one or more bumper elements 36, as shown in the figures, can be mounted to the arms 20 of one or both of the members 14 and/or to the bearing 16. The bumper elements 36 provide resistance when the surface of the bumper element 36 comes into contact with either the surface of another bumper element 36, or the surface of one of the other components of the device 10.

If bumper elements 36 are not utilized to dampen the contact between the surfaces of the different components of the device, then the surfaces themselves can be designed to help resist torsional forces. For example, the arms 20 of the member(s) 14 may be configured such that they can lock against each other, or a surface formed or attached to the bearing, such as that of screws 22, thereby restricting the movement of the two members with respect to torsional forces, but the members are still free to pivot toward and away from each other.

A shear member 24 may also be employed as a torque resistance mechanism, to reduce the damage to the specialized components of the device 10. The shear member 24 is constructed and arranged within the device 10 such that it will break before one of the specialized components of the device 10 reaches its maximum torque resistance.

The components of the device 10, such as torque resistance mechanisms, may also be designed to reduce or eliminate simple and/or harmonic vibrations. This can be accomplished through the materials chosen for the fabrication of the components and through the design of the components.

For example, grommets 38 made from vibration damping materials may be interposed between the connections of the flexible elements 34 and 36 and one or more of the members 12 and/or 14 and/or bearing 16. Additionally, the flexible elements 34 and 36 themselves may be manufactured from vibration damping materials. Therefore, although metallic materials, such as steel or alloys, may provide better resistance, materials such as composites, like carbon fiber, nylon, or combinations of such with high resistance materials may be utilized for some applications, where vibration damping is important.

The bearing 16 may be comprised of any suitable material. For example, metals or ceramics are two such suitable materials.

Although the present invention has been described with reference to preferred embodiments, workers skilled in the art will recognize that changes may be made in form and detail without departing from the spirit and scope of the invention. Since many possible embodiments may be made of the present invention without departing from the scope thereof, it is to be understood that all matter herein set forth or shown in the accompanying drawings is to be interpreted in the illustrative and not a limiting sense.

That which is claimed is:

1. A flexible coupling device, comprising; a first member, a second member, a bearing, and one or more torsion resistant mechanisms, said members each being constructed and arranged to engage said bearing, at least one of said members being moveably engaged with said bearing, said torsion resistant mechanisms constructed and arranged to resist the transmission of a torsional load, applied to one of said members, to the other of said members.

2. The device according to claim 1, wherein at least one of said torsion resistant mechanisms is also constructed and arranged to reduce vibrational forces applied to the device.

3. The device according to claim 1, wherein said torsion resistant mechanisms include one or more flexible elements attached between said first member and said second member.

4. The device according to claim 1, wherein said torsion resistant mechanisms include one or more bumper elements attached to said bearing.

5. The device according to claim 1, wherein said torsion resistant mechanisms include a surface attached to one of said members that engages a surface attached to said other member to restrict the torsional movement of said first and second members with respect to each other.

6. The device according to claim 5, wherein said engagement of said surfaces of said members is constructed to resist a predetermined maximum amount of load, and wherein, a shear member is provided in said engagement of said surfaces, said shear member having a maximum load resistance that is lower than said predetermined maximum load resistance of said engagement of said surfaces.

7. The device according to claim 3, wherein said torsion resistant mechanisms include one or more bumper elements attached to said bearing and one ir more bumper elements attached to one said member.

8. The device according to claim 7, wherein said torsion resistant mechanisms include a surface attached to one of said members that engages a surface attached to said other member to restrict the torsional movement of said first and second members with respect to each other.

9. The device according to claim 8, wherein said engagement of said surfaces of said members is constructed to resist a predetermined amount of load, and wherein, a shear member is provided in said engagement of said surfaces, said shear member having a maximum load resistance that is lower than said predetermined maximum load resistance of said engagement of said surfaces.

10. The device according to claim 1, wherein one of said members has an engagement portion in engagement with said bearing, and wherein said engagement portion is selectively releasable from engagement with said bearing.

11. The device according to claim 1, wherein said torsion resistant mechanisms include one or more bumper elements attached to one said member.

12. The device according to claim 11, wherein said torsion resistant mechanisms further include one or more bumper elements attached to said bearing.

13. The device according to claim 3, wherein said flexible elements are generally L-shaped members having one end engaged with said first member and the other end engaged with said second member.

14. The device according to claim 3, wherein said flexible element has a first end attached to said first member and a second end attached to said second member, and wherein a grommet is interposed between one of said ends of said flexible element and said member to which said end is attached.

15. The device according to claim 4, wherein said bumper elements are resilient ring shaped flexible elements.

16. The device according to claim 1, wherein said torsion resistant mechanisms are comprised of first and second mechanisms and wherein said mechanisms each have a predetermined maximum load resistance, said mechanisms being constructed and arranged such that, when said first mechanism approaches its maximum load resistance, a second mechanism becomes engaged to provide additional resistance to that of said first mechanism.

17. The device according to claim 16, wherein said torsion resistant mechanisms further comprise a third mechanism having a predetermined maximum load resistance and being constructed and arranged such that when first and second mechanisms approach their combined maximum load resistance said third mechanism becomes engaged to provide additional resistance to that of said first and second mechanisms.
